(19) United States
(12) Patent Application Publication
(10) Pub. No.: US 2017/0372401 A1
(43) Pub. Date: Dec. 28, 2017

(54) Context-Aware Personalized Recommender System for Physical Retail Stores

(71) Applicant: Microsoft Technology Licensing, LLC, Redmond, WA (US)

(72) Inventors: Di Wang, Redmond, WA (US); Michel Goraczko, Seattle, WA (US); Dimitrios Lymberopoulos, Kirkland, WA (US); Jie Liu, Medina, WA (US); Marcel Gavriliu, Snohomish, WA (US); Nissanka Arachchige Bodhi Priyantha, Redmond, WA (US); Gerald Reuben DeJean, Woodinville, WA (US); Mohammed Shoaib, Redmond, WA (US); Suman Kumar Nath, Redmond, WA (US)

(21) Appl. No.: 15/192,822

(22) Filed: Jun. 24, 2016

(51) Int. Cl. G06Q 30/06; H04W 4/02

(52) U.S. Cl. CPC G06Q 30/0631; H04W 4/02

(57) ABSTRACT

Providing product recommendations in a physical retail store. A method includes detecting that the user arrives at the physical retail store. The method further includes, in response, receiving information from a recommendation server for a particular user. The method further includes storing locally, the information from the recommendation server. The method further includes, detecting a plurality of user interactions for the user with products in the retail store as part of the shopping experience and prior to a check-out phase of the shopping experience. The method further includes based on the locally stored information and the user interaction, providing product recommendations.

### BACKGROUND

### Background and Relevant Art

In today's physical retail stores, it is difficult to provide an in-store shopper engagement channel for recommending the right products, coupons, promotions, ads, etc. in the right context (e.g., at the appropriate time, location, shopper action, etc.), in the right form (e.g., presentations, explanations, etc.), and/or tailored to the shopper (e.g., meeting each individual shopper's preference).

Rather, stores may have in-store displays for sales and promotions which are not personalized and not interactive based on context. Alternatively or additionally, stores may provide advertisements such as product coupons, sales, recommendations, etc., via mail, checkout point of sale locations, Internet web pages, email, loyalty apps, mobile shopping apps, etc. These advertisements are either not personalized or are personalized based on demographics and/or past purchase history. However, these advertisements do not provide in-store engagement, and recommendations based on a shopper's current actions while shopping in the store.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of providing product recommendations in a physical retail store. The method includes detecting that the user arrives at the physical retail store. The method further includes, in response, receiving information from a recommendation server for a particular user. The method further includes storing locally, the information from the recommendation server. The method further includes, detecting a plurality of user interactions for the user with products in the retail store as part of the shopping experience and prior to a check-out phase of the shopping experience. The method further includes based on the locally stored information and the user interaction, providing product recommendations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a retail store with local recommender system and remote service; and

FIG. 2 illustrates a method of providing product recommendations in a physical retail store.

### DETAILED DESCRIPTION

Some embodiments illustrated herein can provide product recommendations to shoppers in a physical retail store in a performant fashion. In particular, information about a shopper (such as user identifiers, history of past purchases, demographic information, segment information (for example, is the user a working mom, cereal lover, brand fan boy, etc.) medical information (for example, information about a user's allergies, diets, restrictions, medications, etc.) fitness targets, lifestyles, or other information can be provided to the retail store and stored locally at the retail store upon the shopper becoming proximate the retail store. This information is provided by a remote service to the retail store at the time it is determined that the shopper is likely to begin a shopping experience at the retail store. Thus, all of the information needed to provide the shopper with a personalized shopping experience is available locally at the retail store without needing to obtain additional information remotely, allowing advertisements to be quickly and efficiently provided to the shopper without the need to obtain information from a remote service during the shopping experience.

Embodiments may provide a smart shopping cart or other device that can detect user interactions for the shopper with products in the retail store as part of the shopping experience and prior to a check-out phase of the shopping experience. Based on the locally stored information and the user interaction, the smart shopping cart or other device can provide product recommendations.

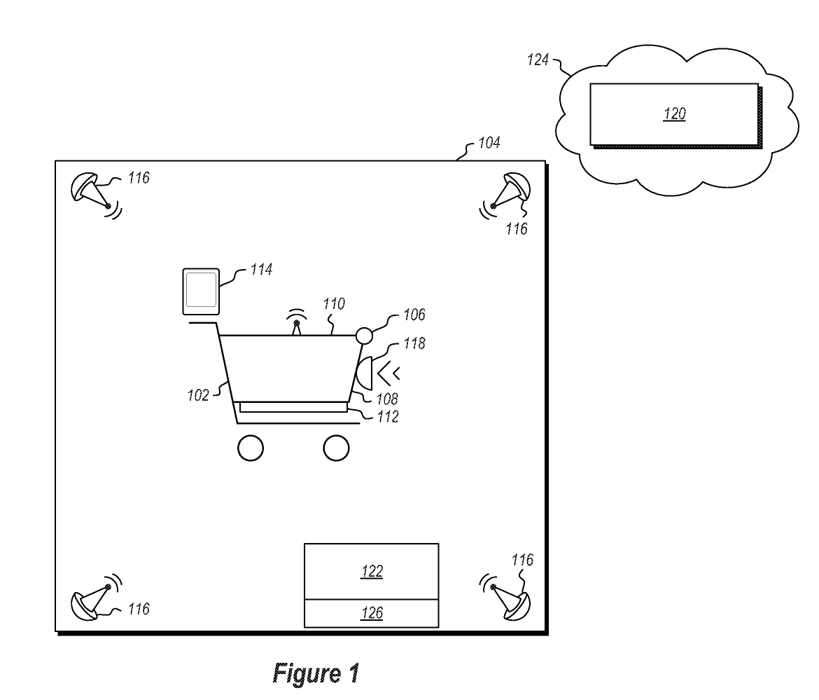

Referring now to FIG. 1, one embodiment can leverage smart shopping carts enhanced by digital devices capable of localizing themselves within a foot of their true locations. The digital devices allow retailers to track shoppers' locations, their dwell time at different product sections, shoppers' heat map in the store, shoppers' interactions with the displays, etc., which capture shoppers' in-store shopping behavior, their product/discount preferences and their real-time shopping context (e.g,, putting things in a shopping cart, or adding things to a shopping list, stopping in front of a product, etc.).

Referring now to FIG. 1, an example is illustrated of a shopping cart 102 and localization infrastructure deployed in the retail store 104. The shopping cart 102 is augmented with various sensors such as one or more of cameras 106 at the top of the basket 108 (although the cameras could be located in other locations) of the cart 102, one or more RF transceivers 110 surrounding the basket 108 (although the antennas could be located in other locations), and/or weight sensors 112 at the bottom of the basket 108 (although the weight sensors could be located in other locations), and a digital device 114, such as a tablet or phone at the cart 102. The digital device 114 can obtain real-time cart location, and computing data from cameras, antennas and sensors for product recognition. Note that the digital device 114 may be substantially permanently attached to the cart 102 while in other embodiments, the digital device could be selectively attachable, or could even be the user's own personal device.

In some embodiments, real time cart location information can be obtained by using transmitters 116, such as ultra-wide-band (UWB) transmitters, such as those available from decaWave of Dublin, Ireland, installed in the retail store 104 which send precise signals that can be received by a receiver 118 used to determine where the shopping cart 102 is located. In some embodiments, the retail store 104 is segregated into tiles to determine which products are to be targeted.

Embodiments may use one or more signals from sensors to determine information. Some embodiments use a multi-signal approach for determining information about products associated with the cart 102. In particular, multiple different sensors may be used, each of which can be used in combination to determine products and their relationship with the cart. In particular, embodiments can determine if products are placed into the cart 102, removed from the cart 102, and/or replaced with other products. Alternatively or additionally, embodiments can determine a products location in a cart.

Using this information, as well as the information for a user from the service 120 remote from the retail store 104, a recommender system 122 at the retail store 104 can deliver the right product, offer, coupon, ads, etc., at the right time to the right person. For example, right after a shopper stops in front of the cereal section, a coupon for a brand of cereal is displayed, or once the shopper puts a cereal box into the shopping cart, certain breads that the shoppers may like are recommended on the screen.

Note that in the illustrated embodiment, the recommender system 122 is local to the retail store 104. Information can be used at the recommender system to make recommendations to a user using the smart shopping cart 102.

In some embodiments, the information for the user is sent to the recommender system 122 at the store 104 from a service 120 in a cloud environment 124. In particular, in some embodiments, information is sent to the recommender system 122 from the service 120 when it is determined that a user has arrived at the retail store 104. In this way, information stored locally at the retail store 104 can be used to create recommendations, where the recommendations are also created locally. Thus, there is no need to call back to the service 120 located remotely during the user's shopping experience. Indeed, in some embodiments, recommendations can be provided locally without calling back to the service 120 after the initial information has been provided from the service 120 to the recommender system.

Embodiments can take into account various details and alternatives related to presentation. This may include information defining what, when, where and how to show recommendations for physical retail shopping. Thus, embodiments may vary a user interface including such things as: layout, brightness, color, font size, etc. on different form factor displays of the digital device 114.

In some embodiments, recommendation and/or offers could be integrated with a shopping list application on the digital device 114, a store layout map on the digital device 114, and/or as part of product search functions on the digital device 114.

Embodiments may include functionality for dynamically changing the diversity and serendipity of recommended categories and the order, or ranking of recommended items within each category based on shoppers' shopping context and interactions with recommendations. For instance, for someone just walking into the store, recommendations may be more diverse and even with unexpected recommendations stimulate and guide shoppers' shopping trips to explore more products. In contrast, when the shopper is nearby the checkout after exploring the store, recommendations may focus more on items she may have forgotten.

Embodiments may show recommendations, coupons, ads, etc., based on a shoppers' locations (e,g., for nearby products), and shopping context (e.g., is the shopper stopped, is the shopper walking, is the shopper scanning an item, did the shopper like an item on a social media application, did the shopper click an item on a shopping application, did the shopper put an item into the cart or remove an item from the cart, what is the shopper's dwell time at a location, characteristics of a shoppers' heat map (e,g., time spent in different parts of the store), etc.)

In some embodiments, recommendation, coupons, explanations and like may be provided to the user with content specifically for the given retail store shopping experiences. For example, embodiments may indicate what other people also bought in a particular aisle, special offers near the shopper, etc.

By continuously tracking shoppers' in-store shopping behavior and context information along with their purchase history, embodiments can build shoppers' long term and short term preference profiles and their responses to external (e.g., visual salience, product image brightness, User Interface (UI) layout, music played in ads, etc.) and internal (e,g., brand preferences, product preference, etc.) influential factors. Moreover, the instantaneous shopping context (e.g., time, location, UI, recommendations) and shoppers' interactions with the system (e.g., clicking a coupon, adding products to a shopping list, etc.) can help facilitate providing a real-time feedback to the recommender system 122, which can be used to adjust preference profiles for the shoppers to provide more accurate targeting with more suitable recommendations.

Once a shopper checks out at the retail store (or even during the shopping visit), information collected during the visit can be uploaded to the service 120.

The following illustrates additional details with respect to a computing infrastructure and pipeline for implementing some embodiments of the invention. In some embodiments, the computing infrastructure includes a computing digital device 114 on the shopping cart, an edge computing node 126 in or near the retail store 104, and a cloud backend, such as the service 120. The computing digital devices on the shopping cart may have energy constraints as they may only be charged during the night or while being docked waiting for a shopper. The other sources are typically not limited by energy but may be limited by network bandwidth and latency.

Two types of data are processed by the infrastructure: streaming data from shopping cart devices (e.g., location, interactions, etc.) and history data (purchase history, archived streaming data, etc.). The real-time data collected by the devices 114 may be first preprocessed locally, such as at the recommender system 122 or at edges and then periodically uploaded to edge nodes such as the edge computing node 126 and/or backend services, such as the service 120. And models, preference profiles analyzed in the edge nodes and backend may be preloaded to the devices and updated periodically for real-time recommendation delivery and traffic reduction, etc.

For different in-store shopping contexts, the requirement of recommendations may be different in terms of (i) response time, (ii) data needed, (iii) diversity, (iv) serendipity, (v) prediction accuracy, etc. These differences may require different computing and storage strategies to achieve the different requirements. For instance, the real-time in-store tracking data may be cached in the shopping cart device 114, and recommendations related to instantaneous behavior can be fully provided by the shopping cart device 114. For example, a shopper puts an item in the shopping cart, and a “frequently bought together” item can be immediately recommended by the device 114 without fetching from backend or edge nodes. On the other hand, for a shopper just walking into a store and logging into the device 114 on the cart, computation across many shoppers in the backend (e.g., the service 120) (to capture long-term preferences) along with computation in the edge node 126 or recommender system 122 for the store (to capture short-term trend, behavior, e.g., current day's trend) is triggered to send recommendations to the devices (e.g., device 114). And these recommendations can be filtered by the device on the shopping cart based on the real-time context such as location, shopper action, etc.

Thus, embodiments may include the ability to engage shoppers with product recommendations, sales, coupons, ads based on shoppers' in-store contextual information and shopping preferences in real-time.

Alternatively or additionally, embodiments may implement a context-aware presentation and explanation of recommendations, sales, coupons, ads for in-store shopping.

Alternatively or additionally, embodiments may include the ability to continuously track shoppers' in-store shopping behavior and responses to external and internal decision influential factors allows the recommender system to learn the long term, short term and instantaneous term preferences, behavior (internal factors) and the influences of user interface, enviromnent, context, etc. (external factors) in affecting shoppers' in-store purchase decisions for better recommendations and targeting.

Alternatively or additionally, embodiments may include a tiered computing, store infrastructure pipeline to support real-time recommendation delivery for different shopping context.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

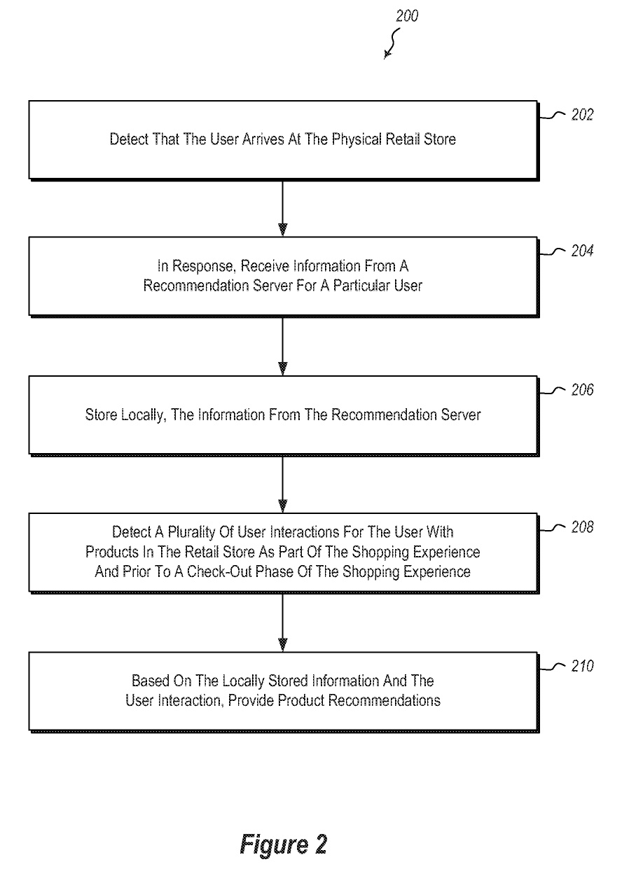

Referring now to FIG. 2, a method 200 is illustrated. The method 200 includes acts for providing product recommendations in a physical retail store.

The method 200 includes detecting that the user arrives at the physical retail store (202). For example, embodiments may detect that a user has arrived at a parking lot for a retail store by using location hardware in a user's phone or other device. Alternatively or additionally, a user may have an RFID loyalty reward device that is able to be detected by hardware at a store that detects a user entering the store. Other detection methods may alternatively or additionally be used within the context of the invention.

The method 200 further includes, in response, receiving information from a recommendation server for the user that is particular to the user (204). In particular, a remote recommendation server may provide information for the particular user. The information may be provided to a local recommendation server at the store.

The method 200 further includes, storing, locally, the information from the recommendation server (206). For example, information may be stored at the recommender system 122 and/or the device 114.

The method 200 further includes, detecting a plurality of user interactions for the user with products in the retail store as part of the shopping experience and prior to a check-out phase of the shopping experience (208).

The method 200 further includes, based on the locally stored information and the user interaction, providing product recommendations (210). For example, the recommendations may be provided at the device 114.

The method 200 may be practiced where storing locally comprises storing at a store server. For example, information may be stored locally at the recommender system 122.

The method 200 may be practiced where storing locally comprises storing at a user device. For example, information may be stored at the device 114.

The method 200 may further include sending information to the server about the user interactions with the product wherein at the server the server processes the information in anticipation of the next user visit to the store. For example, after a visit, information can be sent from the edge node 126 about the current shopping visit to the service 120.

The method 200 may be practiced where providing product recommendations is based on store data collected independent of the user. For example, such information may be based on other users' information, heat maps showing active portions of a store, popular products, etc.

The method 200 may be practiced where the interactions are one or more of stopping at a location in the store, scanning an item in the store for informational purposes, or detecting shopping cart interactions (e.g., products placed in cart or taken out of cart, etc.)

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for
one or more processors; and
one or more computer-readable media having stored thereon instructions that are executable by the one or more processors to configure the computer system to provide product recommendations in a physical retail store, including instructions that are executable to configure the computer system to perform at least the following:
detecting that a user arrives at the physical retail store;
in response, receiving information from a recommendation server for the user that is particular to user;
storing locally, the information from the recommendation server;
detecting a plurality of user interactions for the user with products in the retail store as part of the shopping experience and prior to a check-out phase of the shopping experience; and
based on the locally stored information and the user interaction, providing product recommendations.

2. The system of claim 1, wherein storing locally comprises storing at a store server.

3. The system of claim 1, wherein storing locally comprises storing at a user device.

4. The system of claim 1, wherein one or more computer-readable media further have stored thereon instructions that are executable by the one or more processors to configure the computer system to send information to the server about the user interactions with the product wherein at the server the server processes the information in anticipation of the next user visit to the store.

5. The system of claim 1, wherein providing product recommendations is based on store data collected independent of the user.

6. The system of claim 1, wherein the interactions are one or more of stopping at a location in the store, scanning an item in the store for informational purposes, or detecting shopping cart interactions.

7. The system of claim 1, wherein detecting that a user arrives at the physical retail store comprises detecting a location of a user's device.

8. The system of claim 1, wherein detecting that a user arrives at the physical retail store comprises detecting a loyalty card with an RFID.

9. A method of providing product recommendations in a physical retail store, the method comprising:
detecting that a user arrives at the physical retail store;
in response, receiving information from a recommendation server for the user that is particular to user;
storing locally, the information from the recommendation server;
detecting a plurality of user interactions for the user with products in the retail store as part of the shopping experience and prior to a check-out phase of the shopping experience; and
based on the locally stored information and the user interaction, providing product recommendations.

10. The method of claim 9, wherein storing locally comprises storing at a store server.

11. The method of claim 9, wherein storing locally comprises storing at a user device.

12. The method of claim 9 further comprising sending information to the server about the user interactions with the product wherein at the server the server processes the information in anticipation of the next user visit to the store.

13. The method of claim 9, wherein providing product recommendations is based on store data collected independent of the user.

14. The method of claim 9, wherein the interactions are one or more of stopping at a location in the store, scanning an item in the store for informational purposes, or detecting shopping cart interactions.

15. The method of claim 9, wherein detecting that a user arrives at the physical retail store comprises detecting a location of a user's device.

16. The method of claim 9, wherein detecting that a user arrives a the physical retail store comprises detecting a loyalty card with an RFID.

17. A system for providing product recommendations in a physical retail store, the system comprising:
a product recommender coupled to a remote service storing information about users, wherein the product recommender is configured to identify when a user arrives at a physical store and, as a result to obtain information for the user from the remote service;
one or more sensors coupled to the product recommender configured to detect user actions at the physical store; and
wherein the product recommender is configured to provide recommendations to the user based on the information for the user and the detected user actions.

18. The system of claim 17, wherein the product recommender comprises a system at the retail store.

19. The system of claim 17, wherein the product recommender comprises a mobile device.

20. The system of claim 17, wherein the one or more sensors comprise at least one of one or more cameras, one or more RF transceivers or one or more weight sensors.
